(19) United States
(12) Patent Application Publication
(10) Pub. No.: US 2004/0117349 A1
(43) Pub. Date: Jun. 17, 2004

(54) Intermediary server for facilitating retrieval of mid-point, state-associated web pages

(76) Inventor: Michael Zsolt Moricz, Bellevue, WA (US)

Correspondence Address: OLYMPIC PATENT WORKS PLLC, P.O. BOX 4277, SEATTLE, WA, 98104, US

(21) Appl. No.: 10/731,362

(22) Filed: Dec. 9, 2003

Related U.S. Application Data
(60) Provisional application No. 60/432,071, filed on Dec. 9, 2002.

(51) Int. Cl. G06F 7/00

(52) U.S. Cl. 707/1

(57) ABSTRACT

An intermediary server is disclosed that facilitates direct access, by Internet users, to web pages that normally occur as mid-point web pages within predetermined access pathways provided and enforced by source servers. The intermediary server comprises a server component, through which client computers request mid-point web pages on behalf of Internet users running on the client computers, and a server component that interacts with source servers in order to obtain the mid-point web pages from the source servers. The intermediary session server maintains associations between client computers, URLs, and parameter strings so that, upon receiving a URL request from a particular client computer, the intermediary session server can supply the associated parameter string to an instance of a finite state machine within the intermediary server's server component that carries out a web-page-based conversation with the source server in order to navigate to, and obtain, the mid-point web page requested by the client computer.

### CROSS REFERENCE

This application claims the benefit of Provisional Application No. 60/432,071, filed Dec. 9, 2002.

### TECHNICAL FIELD

The present invention relates to web browsing and web servers and, in particular, to an intermediary session server that, in response to a web-page request from a client, accesses a source server on behalf of the client to obtain for the client the requested web page.

### BACKGROUND OF THE INVENTION

During the past ten years, the Internet has evolved from a specialized, text-message and file-transfer medium used within software and hardware companies and research organizations to a widespread, multi-media communications medium through which individuals can access a staggering array of information and service providers. Evolution of the Internet from the original file-transfer and text-message-based medium to a consumer information medium has been accompanied by the development and evolution of a number of intermediary Internet-based services to facilitate consumer access to information and services. Examples of intermediary services include the search services provided by various search engines, including Google, Yahoo, Lycos, and other commercial search engines accessed by Internet users through static web pages.

FIG. 1 illustrates one process by which Internet users currently access information and services provided by source servers. An Internet user accesses the Internet through a web-browser application running on a client computer 102. In response to user input, the web-browser application transmits a hypertext-markup-language (“HTML”) file request, in the form of a universal resource locator (“URL”) 104, to a source server 106 interconnected with the client computer via the Internet. Although the interconnection is represented as being direct in FIG. 1, the URL request may be transmitted over many different links and through many different routers and intermediate computers between the user's client computer 102 and the source server 106. In response to the HTML document request, the source server 106 returns the requested HTML document 108 to the client computer 102, where the contents of the HTML document are rendered and displayed to the user via the user's web-browser application.

The web-page access operations illustrated in FIG. 1, the initial Internet-server implementations, are carried out in an essentially stateless fashion. A client computer requests a first web page, the URL for which is obtained from a stored list of URL's within the web browser or some other source of URL entry points, and subsequent URL's are obtained either from such client-computer-based lists, or from the HTML documents returned by the source server. A user may navigate a list or network of linked web pages, either from an initial starting-point web page, from which subsequent URL's are obtained, or from stored lists of URL's. In these stateless, web-page-based conversations between client computers and source servers, each web page provided by a source server is directly accessible by the client computer, regardless of the prior conversation. In other words, once a client computer obtains the URL for a web page, the client computer is able to directly access that web page by requesting the web page from the source server. Web-page-based conversations between client computers and source servers is, in the initial Internet-server implementations, a strictly request/reply conversation, with the client computer essentially asking questions, and the source server responding to the questions by transmitting HTML documents to the requesting client computer.

As the Internet has evolved, source servers have become more complex, and the types of web-page-based conversations carried out via URL requests and returned HTML documents has grown more complex. To facilitate many types of more complex conversations, source servers may now associate allowed-transition states with web pages in order to direct access of web pages through pre-determined pathways or predetermined conversations. In these more complex conversations, a source server receives current state information from a client computer in order to determine the web pages currently accessible by the client computer or, in other words, to determine the point in a predetermined conversation currently occupied by the client computer. The state information may be embedded in the URL request or may reside on the client computer as a persistent or transient state encoding, such as in a cookie received by the client computer from the source server in a HTML document. Thus, a client computer is directed, via the state associated with the client computer, by the source server through a finite number of predetermined pathways for traversing the web pages served by the source server.

The state-based web-page conversations present a significant problem to search engines. The state information, as discussed below, may be time-dependent as well as client-dependent, but search engines need to index web pages served by a large number of source servers in a time-independent and client-independent fashion. Moreover, when state information is used by source servers in order to implement transactions through web-page conversations with client computers, short circuiting predetermined web conversations by search engines may lead to many different kinds of inconsistencies and problems. Therefore, Internet users, search-engine vendors, and web-page providers have all recognized the need for a way for Internet users to directly and efficiently find and access web pages normally served within predetermined pathways by source servers.

### SUMMARY OF THE INVENTION

In one embodiment of the present invention, an intermediary server is provided to facilitate direct access, by Internet users, to web pages that normally occur as mid-point web pages within predetermined access pathways provided and enforced by source servers. The intermediary server comprises a server component, through which client computers request mid-point web pages on behalf of Internet users running on the client computers, and a server component that interacts with source servers in order to obtain the mid-point web pages from the source servers. The intermediary session server maintains associations between client computers, URLs, and parameter strings so that, upon receiving a URL request from a particular client computer, the intermediary session server can supply the associated parameter string to an instance of a finite state machine within the intermediary server's server component that carries out a web-page-based conversation with the source server in order to navigate to, and obtain, the mid-point web page requested by the client computer.

### BRIEF DESCRIPTION OF THE DRAWINGS

FIG. 1 illustrates a process by which Internet users currently access information and services provided by source servers.

FIG. 2 illustrates a number of problems that arise from state-based source-server interactions.

FIG. 3 shows an example session-based web page navigation.

FIG. 4 illustrates a potential problem arising when session ID's are used by a source server to implement transactions.

FIG. 5 illustrates an approach by which a specific path, or traversal, of linked web pages may be specified by state transitions.

FIG. 6 is a schematic diagram of one embodiment of the present invention.

FIG. 7 is a control-flow diagram for a finite-state-machine thread that executes within the server component of one embodiment of the intermediary session server in order to obtain a unique state and web page for a requesting client computer.

FIGS. 8A-B illustrate operation of the intermediary session server in a context of the example web-page navigation illustrated in FIGS. 3-5.

FIGS. 9A-B illustrate multi-threaded, concurrent access to mid-point web pages by two different users through a single intermediary session server.

FIGS. 10A-B illustrate concurrent access of a mid-point page by two users, as illustrated in FIGS. 9A-B, in a more optimal fashion.

FIGS. 11A-B illustrate another type of mid-point page.

FIGS. 12A-C illustrate the other type of mid-point page shown in FIGS. 11A-B in greater detail.

FIG. 13 is a control-flow diagram that shows an embodiment of the setup procedure for the intermediary session server.

FIG. 14 is a control-flow diagram of one embodiment of the run-time operation of the session server.

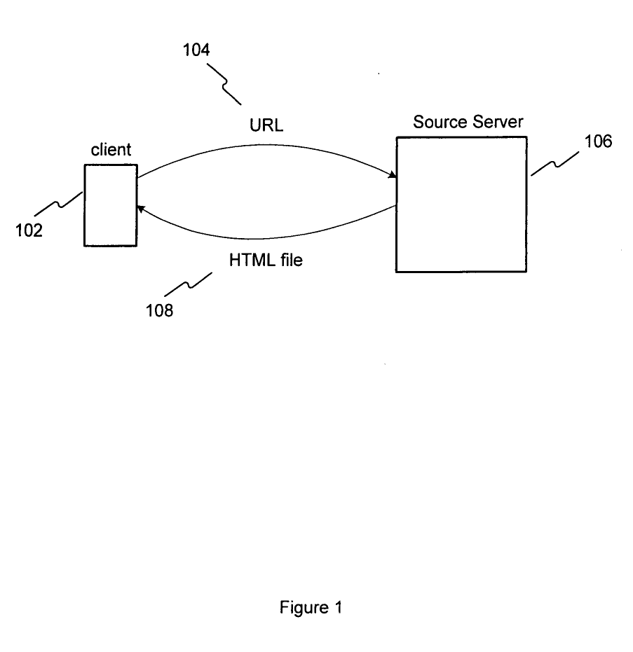

### DETAILED DESCRIPTION OF THE INVENTION

The intermediary server that represents one embodiment of the present invention is described, below, in overview, with respect to a hypothetical example, and in control-flow diagrams. In addition, Appendix A includes Perl-like pseudocode implementations of an abbreviated intermediary server and several finite state machine implementations.

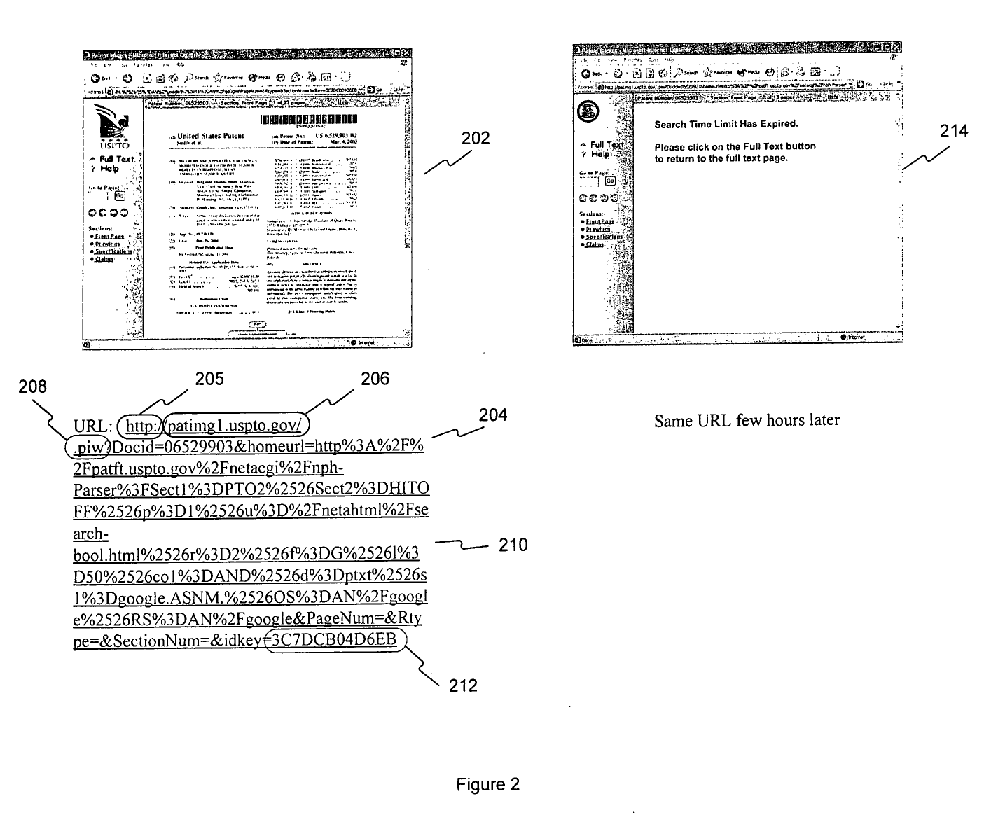

FIG. 2 illustrates a number of problems that arise from state-based, source-server interactions. In FIG. 2, the left-hand screen capture 202 shows a display of a web browser on a client computer. In the case shown in FIG. 2, the web browser displays the first page of an issued United States patent obtained from the USPTO website. Generally, in order to elicit display of a desired patent, the user has first undertaken a search to identify the USPTO website, and then accessed the USPTO website through a state-based, web-page conversation in order to search a database of issued patents for the desired patent. In many cases, a significant amount of time and effort is expended by the user in order to arrive at the display of a desired patent, shown in the screen capture 202 in FIG. 2. The URL request 204 immediately preceding the web-browser display is shown in FIG. 2 below the left-hand screen capture as a lengthy text string. This text string includes a transfer protocol, such as the transfer protocol “http” 202, used to request the web page, a domain name identifying the source server 206, the path and name of an executable invoked by the URL request on the source server 208, and a lengthy parameter list 210 that may be employed by the invoked executable or by the server in order to specify and facilitate the access requested by the client computer. In the URL 204 shown in FIG. 2, the parameter list includes a session ID 212 that identifies the web-page-based conversation undertaken by the user's web browser in order to arrive at the display shown in FIG. 2.

Upon achieving the desired display, the user may elect to bookmark the URL in order to later return to again display the patent by employing the bookmark feature of the user's web browser. The web browser saves URL 204 in association with an easy-to-remember character string, by which the user may subsequently find and access URL 204 for later display of the desired patent. However, many hours later, when the user inputs a desire to access the bookmarked URL to the web browser, unexpected events may occur. If the web browser cached the display shown in the screen capture 202, the user may recover the display through the bookmarked URL from the user's local client computer. However, when the user attempts to display the next page in the patent, the user's web browser may instead display the information shown in the right-hand screen capture 214 in FIG. 2. This display 214 results from the fact that the source server maintains a particular client/source-server conversation, or session, for only a short period of time. In the interim between bookmarking the URL and attempting to re-access the patent via the bookmarked URL, the session associated with the client computer on the source computer has expired. In this case, the user would need to repeat the navigation steps initially needed to locate the USPTO website and navigate through the USPTO website to the desired patent. This represents an annoying and time-inefficient web-page access for the user. However, for search engines, such session time-outs represent a much more serious problem. A search engine simply cannot index a URL for the patent displayed in screen capture 202, since the session associated with the URL will have almost certainly expired before the search engine has an opportunity to provide that URL to another Internet user.

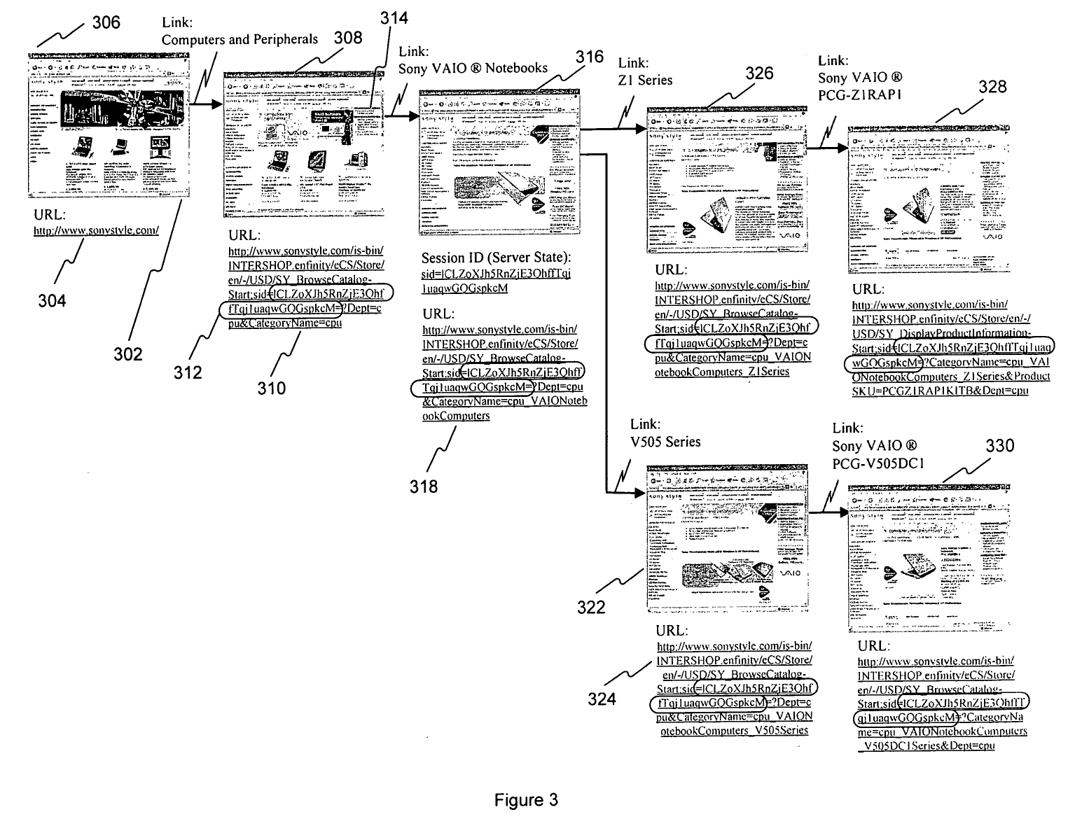

FIG. 3 shows an example, session-based web page navigation. In FIG. 3, a user, through the user's web browser, may initially access a static web page 302 using the URL for the static web page 304. Display of the web page is shown by screen capture 306 in FIG. 3. By clicking a hyperlink displayed by the web browser in the initial web page 302, the user directs the user's web browser to request a second web page 308 using URL 310. Note, however, that URL 310 includes a session ID 312 embedded within the first web page 306 by the source server. In other words, when the user assesses the first web page 306, the first server instantiates a session on behalf of the user, and associates the session ID for that session with all hyperlinks in the first web page. Therefore, when the user's web browser supplies a URL extracted from the first page to the source server, the user's web browser passes to the source server both an identification of a next page for display as well as the session ID associated with the client computer. Access of the first web page 306 via the static URL 304 represents an essentially stateless interaction with the source server. Access of all subsequent pages, via hyperlinks on the first and subsequent web pages, represents a state-based conversation with the source server that follows one of a number of predetermined paths.

Upon receiving the second page 308, the user may select any of a number of menu items via mouse clicks in order to request subsequent pages. Selecting one displayed menu item 314 causes the web browser to request a subsequent, third web page 316 using URL 318. Depending on which menu item is selected from the third displayed page 316, two different pathways may be traversed. The first of the two pathways includes web pages 326 and 328, and the second pathway includes web pages 322 and 330. All of the subsequently accessed web pages 308, 316, 322, 326, 328, and 330, are associated with URLs that include the session ID 312 assigned by the source server to hyperlinks within the first page 306 upon request of the first page by the user's web browser.

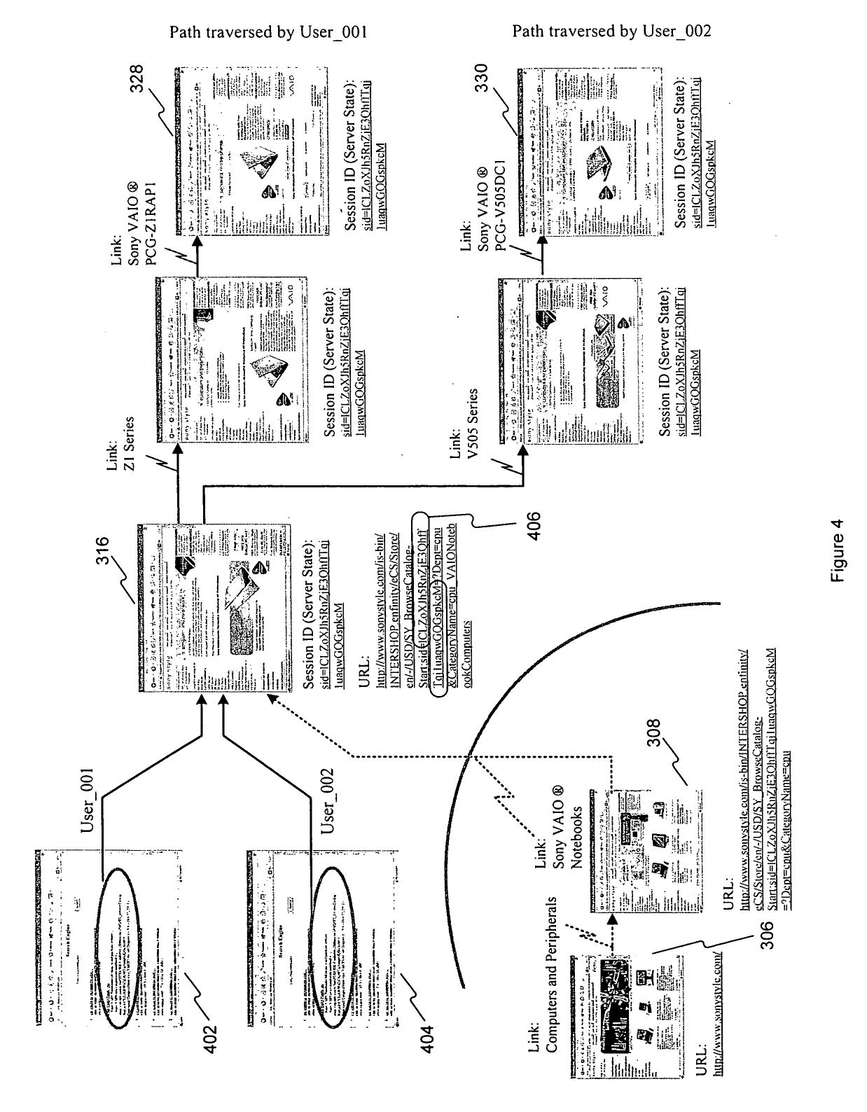

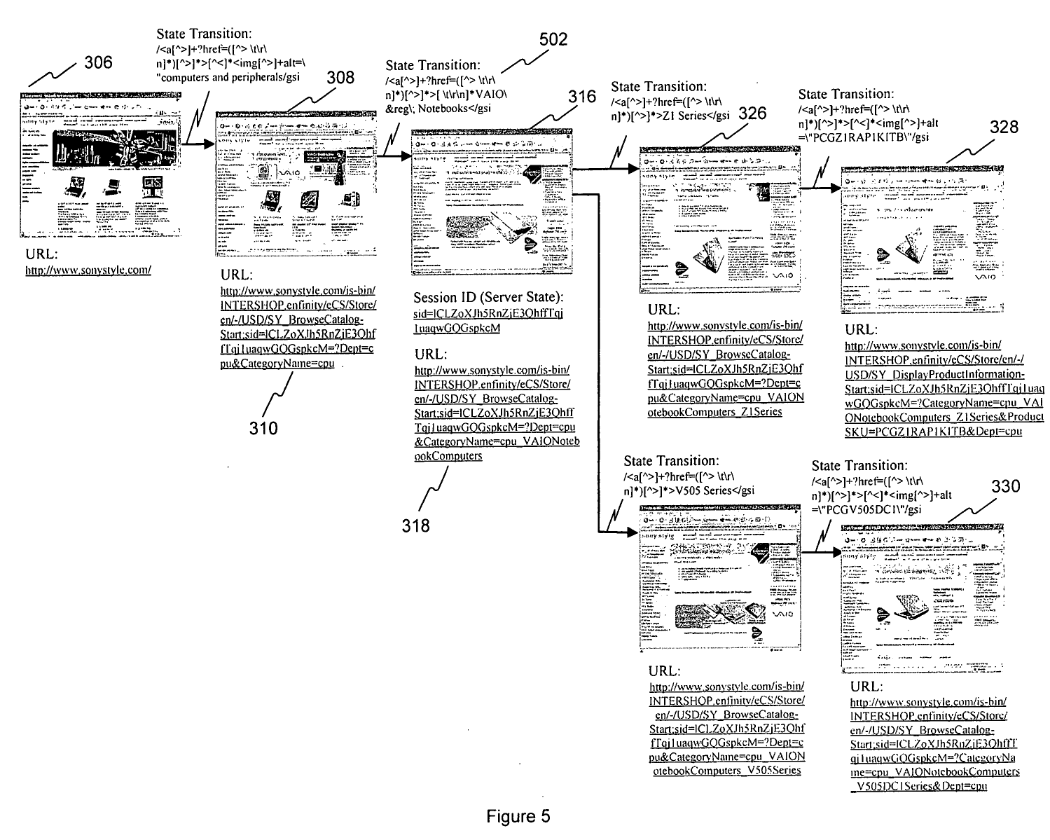

FIG. 4 illustrates a potential problem arising when session IDs are used by a source server to implement transactions. As shown in FIG. 4, two different users, represented by two web pages displayed to the two users 402 and 404, access a search engine in order to obtain a URL for web page 316, normally obtained by traversing web pages 306 and 308, as shown in FIG. 3. The search engine initially traversed web pages 306 and 308 in order to obtain web page 316, and stored the URL associated with page 316 in persistent storage for provision to users, such as users 402 and 404, at a later time. However, the URL stored by the search engine includes a session ID 406 generated by the source server upon initial access of the first page 306 by the search engine. Therefore, when 402 and 404 obtain the URL from the search engine, users 402 and 404 directly navigate to web page 316 within the context of a single session identified by session ID 406. Subsequently, users 402 and 404 may independently navigate to different web pages 328 and 330. However, the two users 402 and 404 are concurrently accessing the two different web pages 328 and 330 within the context of the same session ID 406, as would be any other user accessing web page 316 via the search engine. If the first server employs session IDs to implement transactions, the situation illustrated in FIG. 4 represents a violation of the transaction semantics. For example, both users 402 and 404 may elect to order the laptop computers displayed in screen captures 328 and 330. The source server may employ the session ID returned by the user's web browsers as essentially a transaction ID in order to differentiate concurrently accessing users. However, since both users have the same session ID, the source server interprets all requests made by the two users in the context of a single transaction, potentially resulting in a variety of serious problems, including the account of one user being debited for both purchases, users receiving computers ordered by other users, and other such serious problems. Therefore, in the case illustrated in FIGS. 3-4, even though the source server does not time-out session ID's, the fact that a search engine has accessed the web page in the context of one session ID, and distributed that session ID to multiple Internet users accessing the web page through the search engine, serious problems result. Of course, when source servers employ session IDs for implementing transactions, source servers normally incorporate rather short timeouts in order to prevent the situation described with reference to FIG. 4. In that case, the search engine cannot provide URLs for mid-point pages that follow an initial statically addressed web page for the reasons discussed above with reference to FIG. 2. However, regardless of how short the timeout period is made, there remains a potential for multiple-user-access through a single session ID.

FIG. 5 illustrates an approach by which a specific pathway through or traversal of, linked web pages may be specified by state transitions. FIG. 5 uses the example web-page traversals employed in FIGS. 3 and 4. As shown in FIG. 5, each step in the traversal of the web pages, such as the traversal step between web page 308 and web page 316, can be fully specified by the URL 310 for the first web page of the step, and a state-transition-specifying string 502 that indicates the link within the first web page 308 that specifies the second web page of the step. For example, in FIG. 5, the state transition string 502 specifies the menu selection in web page 308 associated with URL 318 that specifies web page 316. The state-transition strings, such as state-transition-string 502, may be the numerical order of the link within the web page, search criteria for identifying the URL within the first web page, or other types of identifying information by which a parsing and processing routine can identify and extract a particular URL from a web page. As shown in FIG. 5, each web-page-navigation step is fully characterized by a state-transition string and the URL of the currently displayed web page. Moreover, any mid-point web page or, in other words, web page within a navigation pathway displayed following display of the initially displayed web page 306, can be fully specified by the URL of the initial web page and a concatenation of the state-transition strings of the steps leading to the mid-point web page. In the following discussion, the individual, step-associated state-transition strings are referred to as “parameter substrings,” and the concatenation of state-transition strings specifying a particular web page is referred to as the “parameter string” for the particular web page.

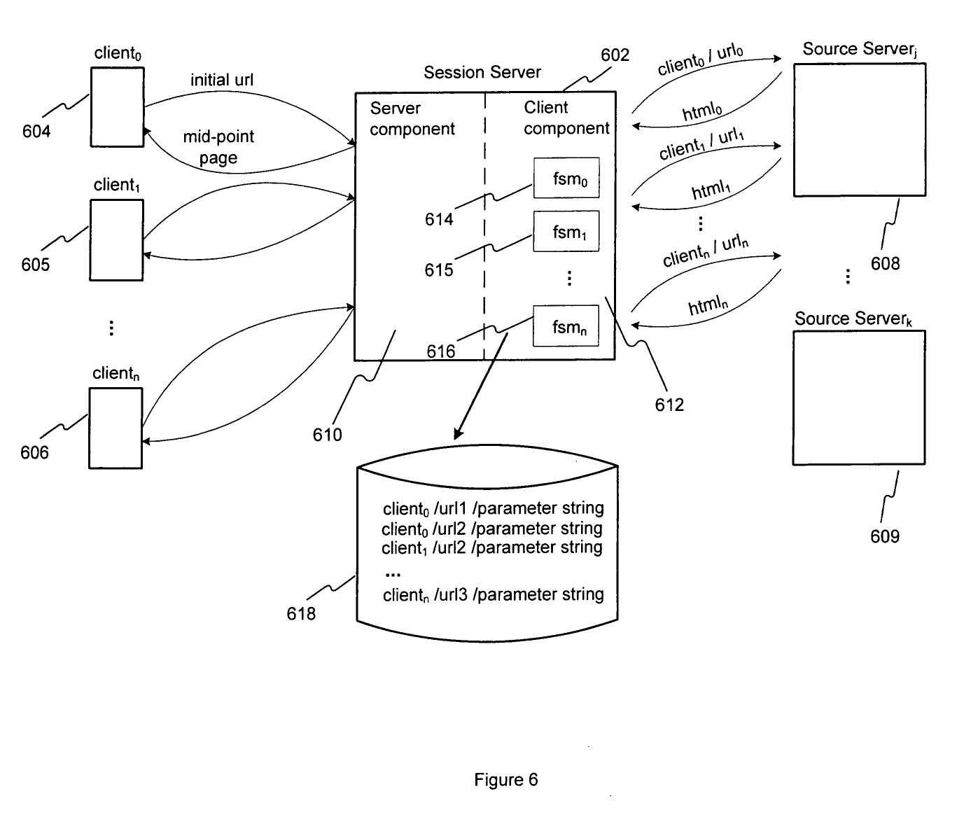

FIG. 6 is a schematic diagram of one embodiment of the present invention. As shown in FIG. 6, the problems discussed above, with reference to FIGS. 3-5, regarding state-based web-page navigation, can be addressed by introducing a new intermediary session server 602 between users accessing the Internet via web browsers running on client computers 604-606 and one or more source servers 608-609. The intermediary session server 602 may physically reside on the same or a different computer system from a source server.

The intermediary session server 602 includes a server component 610 and a client component 612. The server component 610 of the session server 602 receives URL-based requests from client computers 604-606, and returns to the client computers 604-606 the HTML documents specified by the received URLs. The client component 612 of the intermediary session server 602 includes a finite-state-machine thread 614-616 corresponding to each currently accessing client computer 604-606. The finite-state-machine thread for a client computer conducts state-based web-page navigation with a source server 608 in order to access the web page initially requested by the client computer. If the client computer requests a mid-point web page, as discussed above with reference to FIGS. 2-5, the finite-state-machine thread carries out the state-based web-page navigation needed in order to obtain the requested mid-point page within a unique state context that can be returned, along with the mid-point page, to the client computer. In other words, if the source server employs session IDs, as discussed above with reference to FIG. 5, the intermediary session server 602 obtains a unique session ID, along with a requested web page, from the source server that can be returned to the client computer. The intermediary session server 602 maintains a database 618 of associations between client computers, URLs, and parameter strings to allow the intermediary session server to obtain a parameter string matching a received URL-based request from a particular client computer that can be forwarded to a finite-state-machine thread instantiated for the client computer to direct the state-based web-page navigation needed to obtain the unique state and requested web page.

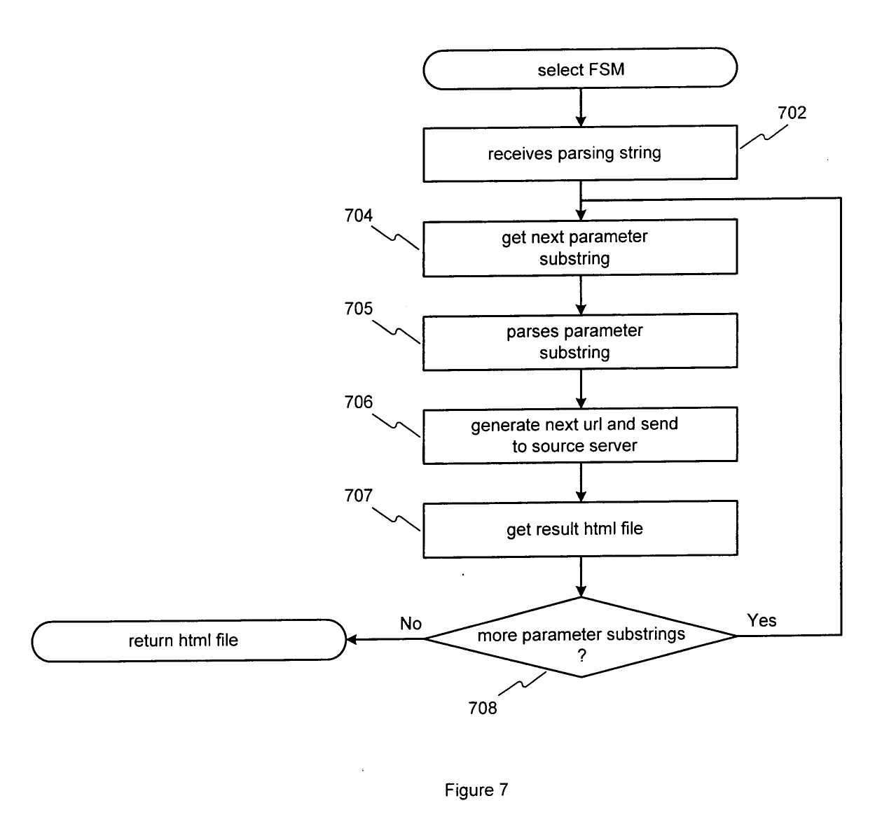

FIG. 7 is a control-flow diagram for a finite-state-machine thread that executes within the server component of one embodiment of the intermediary session server in order to obtain a unique state and web page for a requesting client computer. In step 702, the finite-state-machine thread (“FSM”) receives a parameter string extracted from a client/URL/parameter-string string association stored by the intermediary session computer in a database (618 in FIG. 6). In the loop comprising steps 704-708, the FSM extracts parameter substrings from the parameter string, carrying out one step of state-based web-page navigation with a source server for each extracted parameter substring. In step 704, the FSM gets the next parameter substring from the received parameter string. In step 705, the FSM parses the parameter substring in order to identify a next URL to supply to the source server. In step 706, the FSM obtains the next URL, either directly from the parameter string or from a web page previously obtained from the source server, and requests the HTML document corresponding to the next URL from the source server. In step 707, the FSM receives the requested HTML document from the source server. If there are more parameter substrings within the received parameter string, as determined in step 708, control flows back to step 704. Otherwise, the FSM returns the last obtained HTML document to the server component of the intermediary session server 602, which, in turn, sends the HTML document to the requesting client computer.

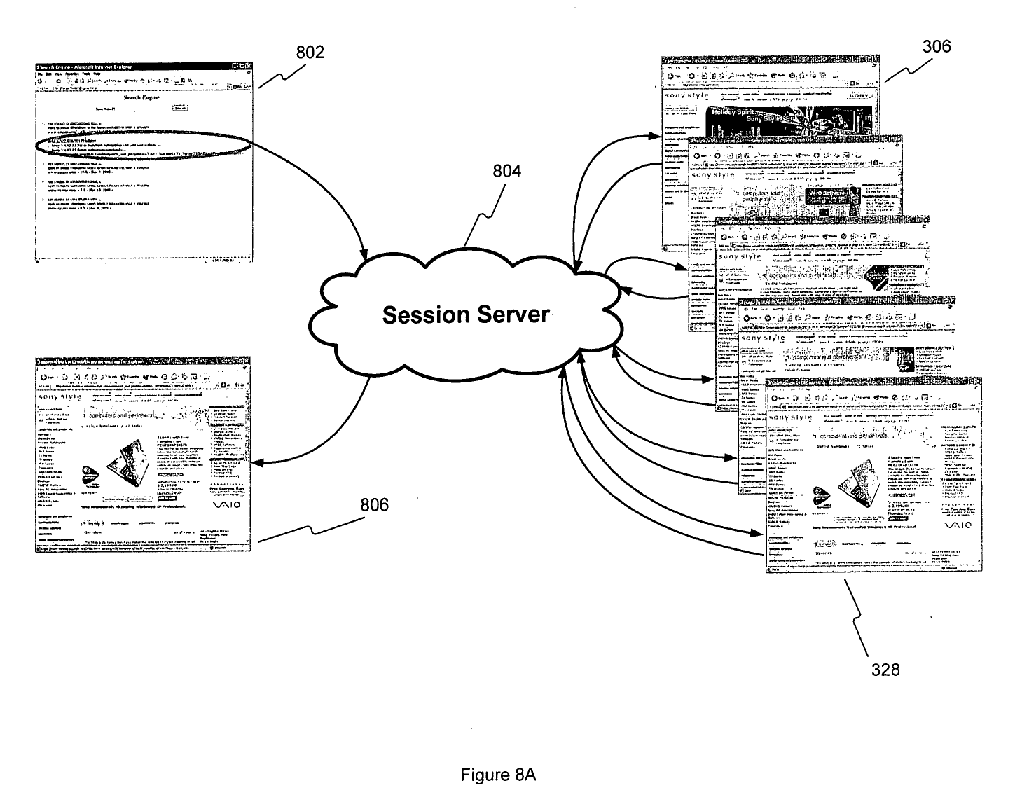

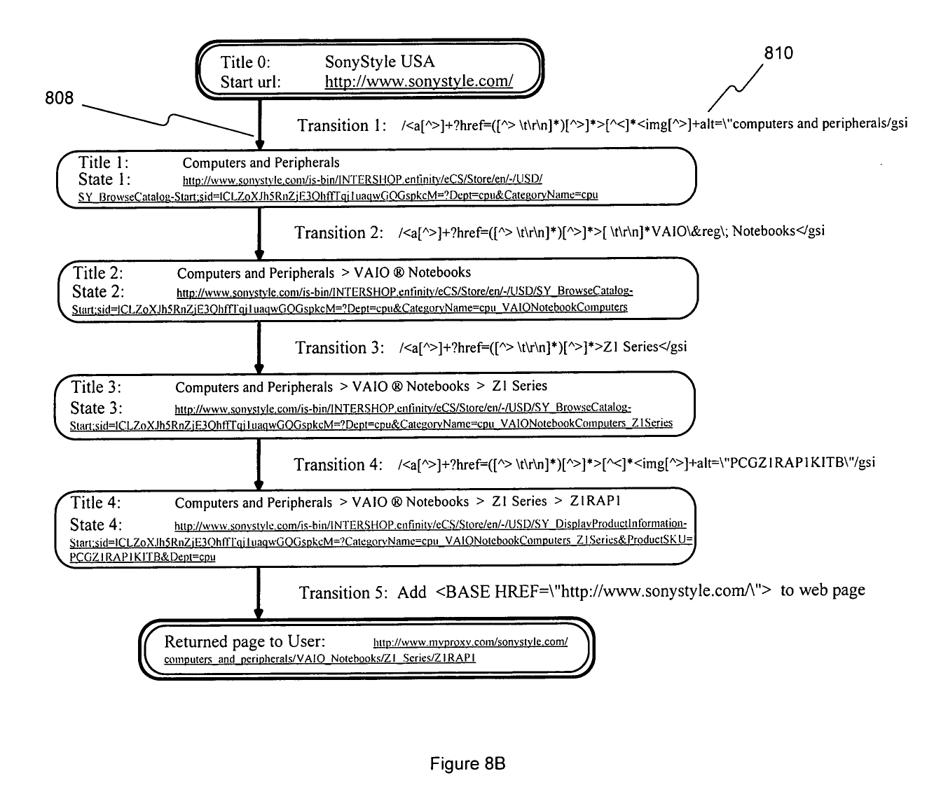

FIGS. 8A-B illustrate operation of the intermediary session server in a context of the example web-page navigation illustrated in FIGS. 3-5. As shown in FIG. 8A, a user obtains the URL for a mid-point page via a search engine 802. The URL is not, however, the URL that specifies the mid-point page to the source server, but is instead a URL that can be supplied to the intermediary session server 804 in order to obtain from the intermediary session server 804 the requested mid-point web page 806. The intermediary session server 804, upon receiving the URL from the user, carries out the initial portion of the web-page navigation that leads from the first, static web page 306 to the requested, mid-point web page 328. By doing so, as discussed above, the intermediary session server obtains not only the requested mid-point web page 328, but also the appropriate unique session ID that is returned to the requesting client computer 806 along with the requested mid-point web page 328.

FIG. 8B shows the detailed state-transition-based navigation undertaken by a finite-state-machine thread within the client component of the intermediary session server on behalf of the requesting client computer. In FIG. 8B, each step of the navigation pathway, or transition, is represented by a vertical, downward pointing arrow, such as arrow 808, and is shown in association with a parameter substring, such as parameter substring 810 associated with the first step 808.

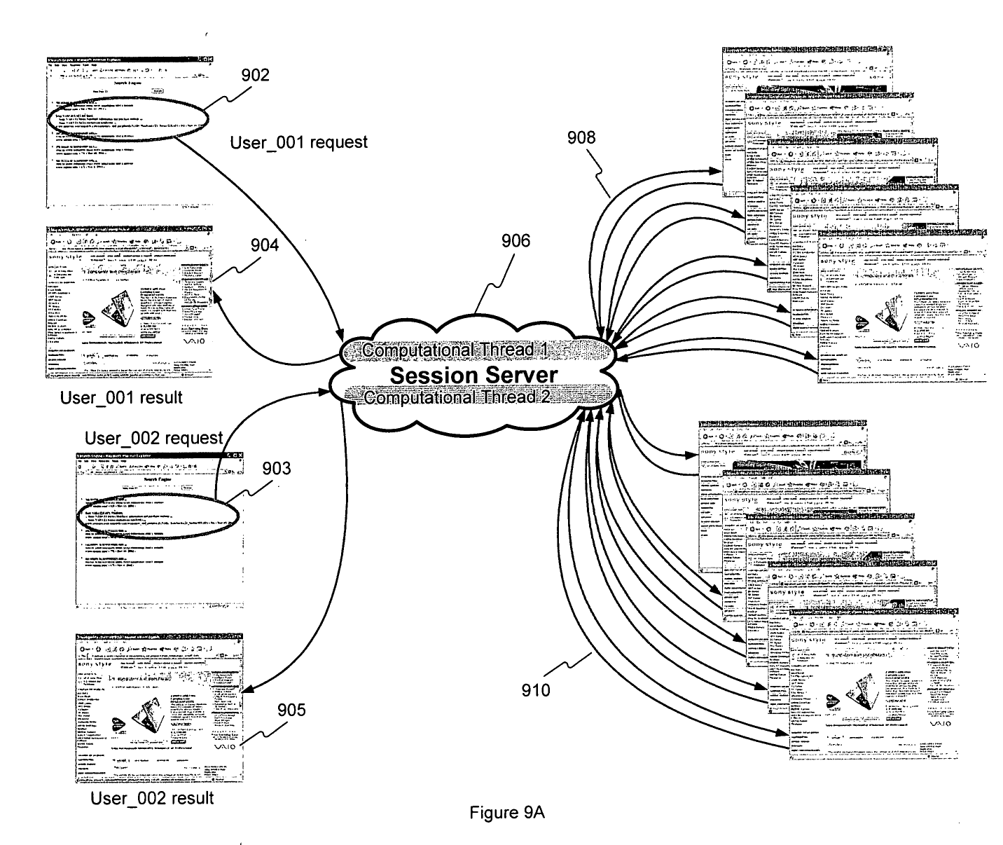

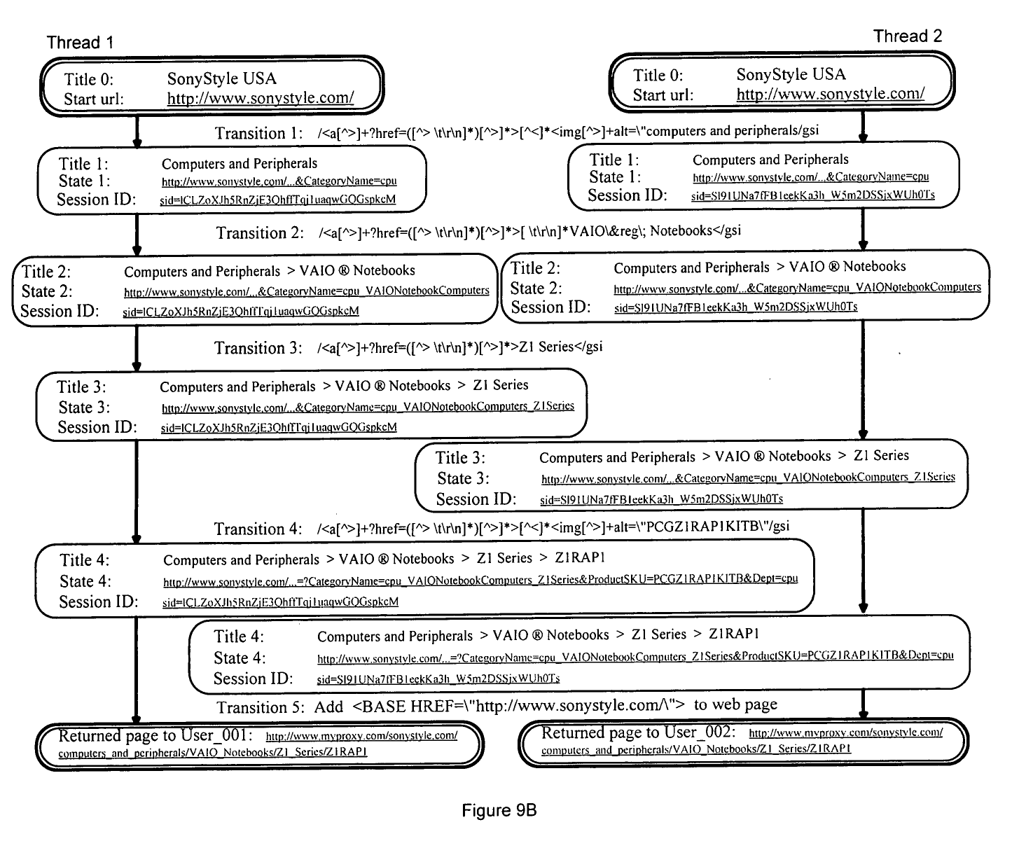

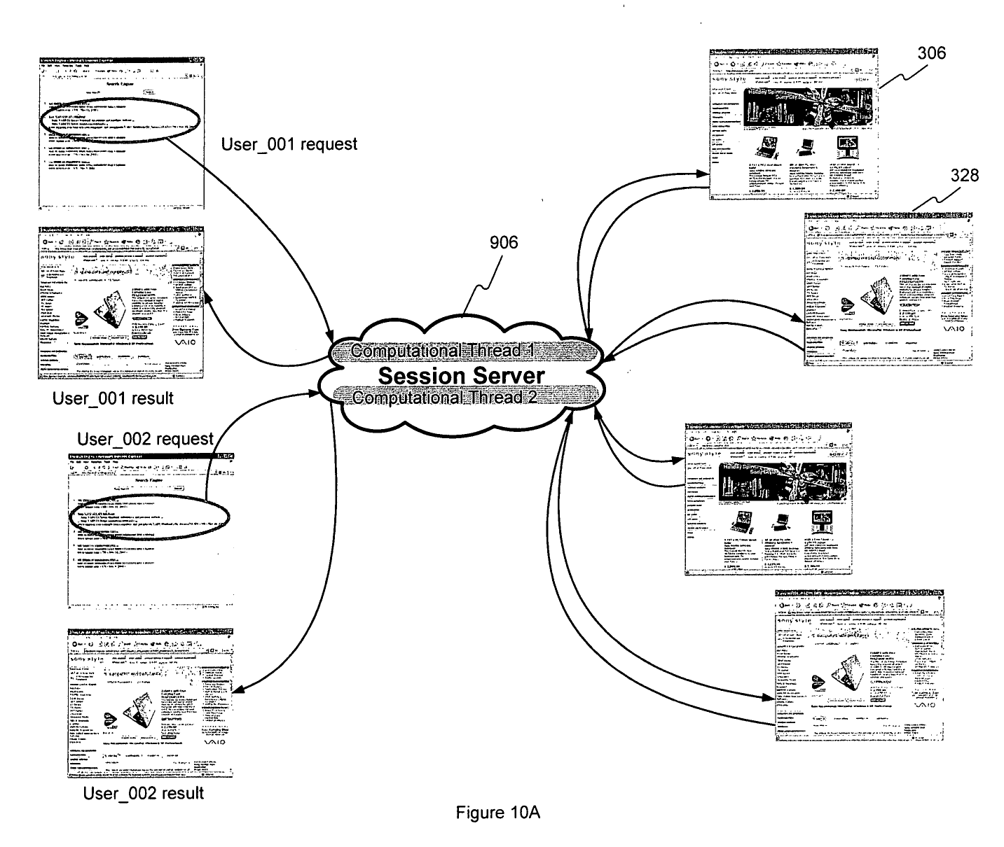

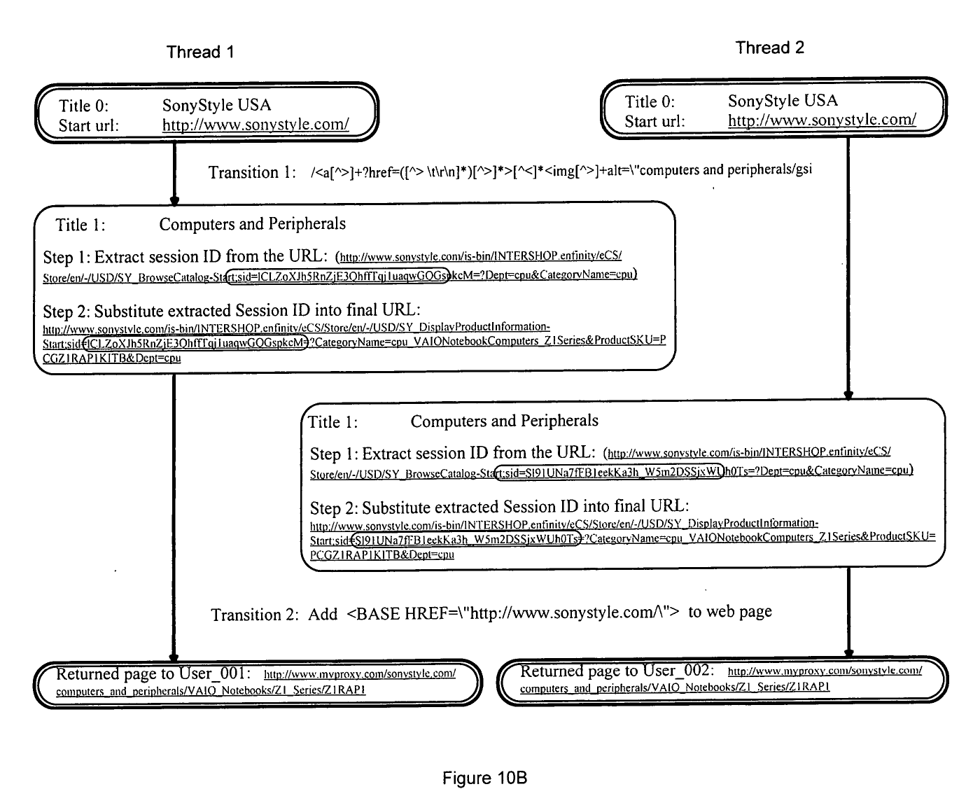

FIGS. 9A-B illustrate multi-threaded, concurrent access to mid-point web pages by two different users through a single intermediary session server. As shown in FIG. 9A, even though a first user and a second user both request the same mid-point page via identical URLs 902 and 903 obtained from a search engine, by accessing the mid-point pages 904 and 905 through the intermediary session server 906, each user receives the mid-point page associated with a session ID unique to that user, as a result of the intermediary session server conducting separate navigations 908 and 910 of the web pages provided by the source server. FIG. 9B shows the state-transition-based navigation of the web pages provided by the source server by two discreet, finite-state-machine threads on behalf of the two users, as shown in FIG. 9A, using the illustration conventions of FIG. 8B.

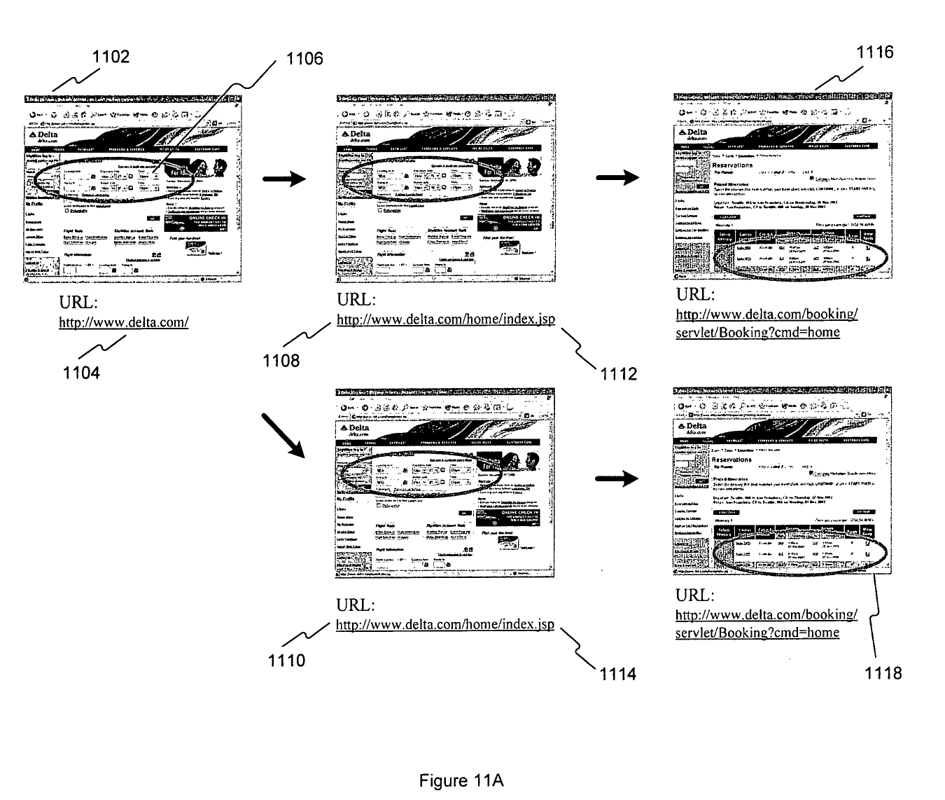

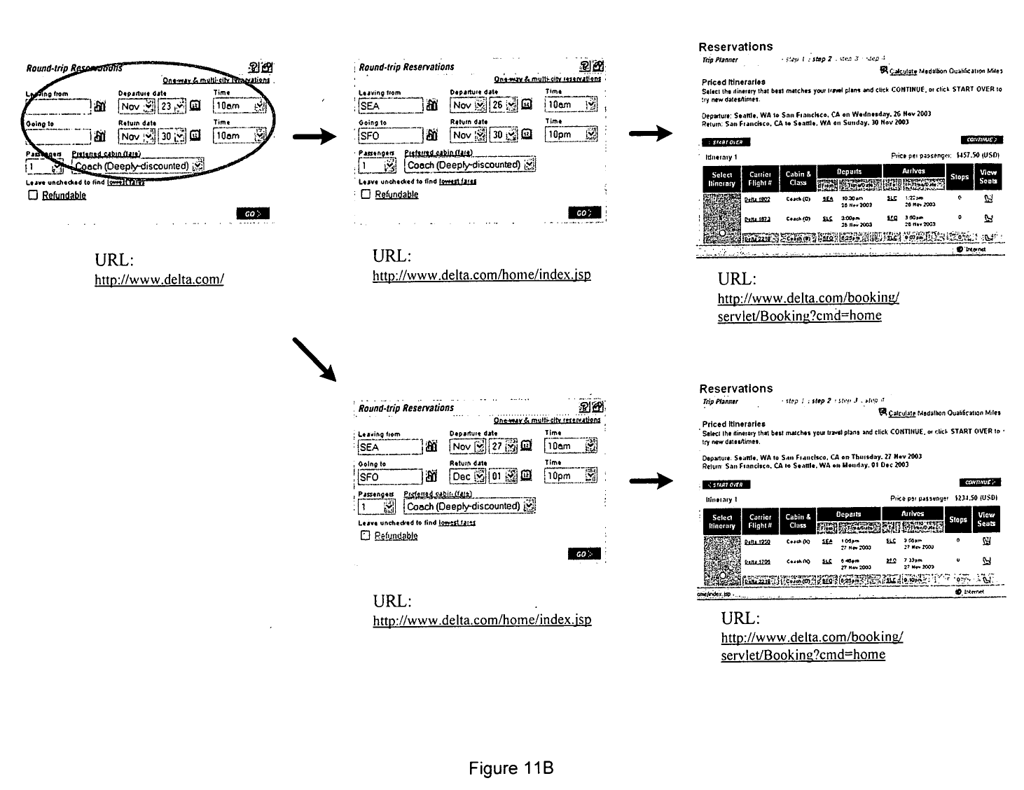

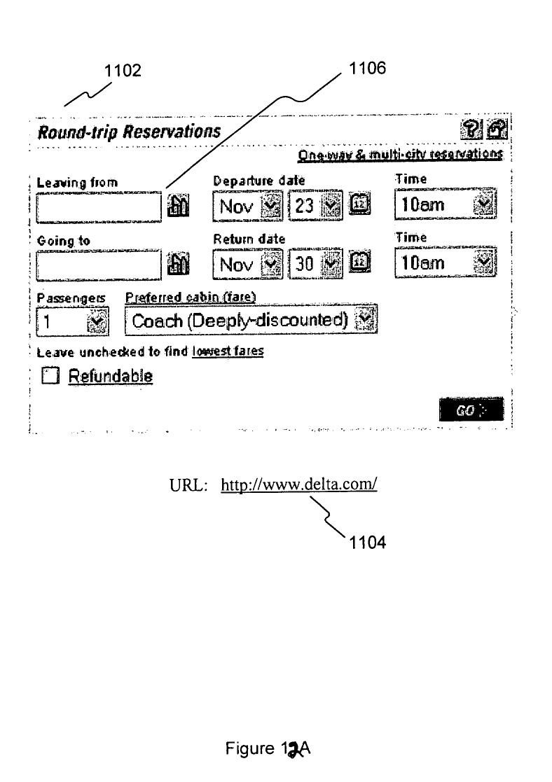

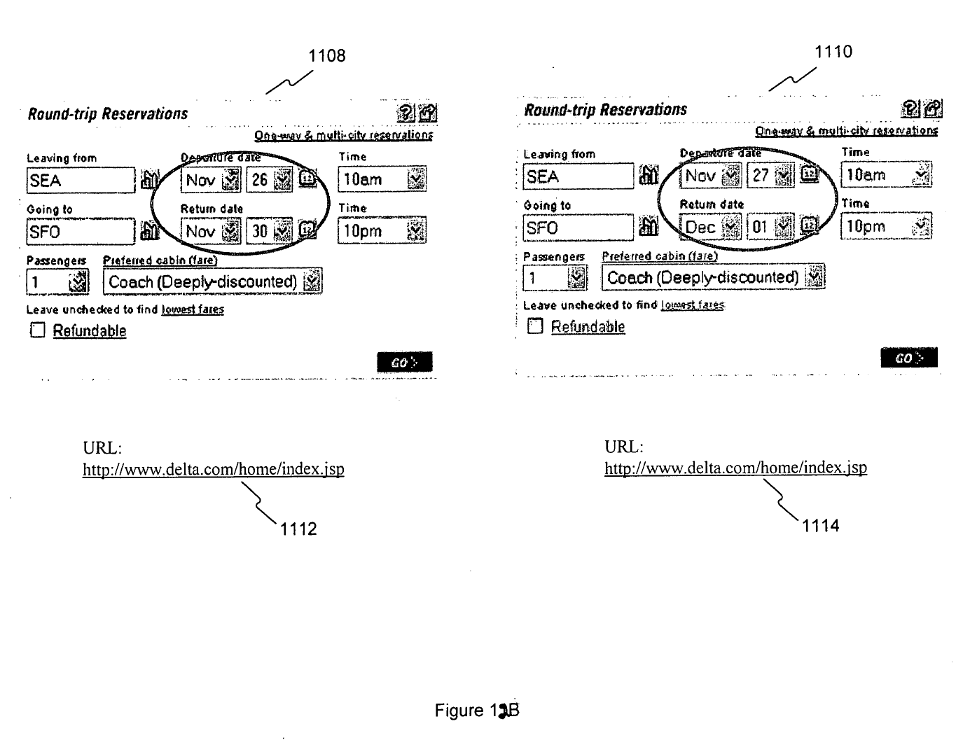

FIGS. 10A-B illustrate concurrent access of a mid-point page by two users, as illustrated in FIGS. 9A-B, in a more optimal fashion. As shown in FIG. 10A, in the context of a web-page navigation discussed with reference to FIGS. 3-5, the intermediary session server 906 may not actually need to traverse each mid-point page within the navigational pathway leading to a requested mid-point page. Instead, in most cases, the intermediary session server can recognize the fact that the session IDs are essentially assigned when the first requested, static page 306 is returned by the source server. Therefore, the intermediary session server may short circuit the navigation once the session IDs are obtained as a result of accessing the first static page 306, and navigate directly to the desired mid-point page 328 providing that the intermediary session server has stored the non-session-ID portion of the URL specifying the mid-point web page 328. In one embodiment, the URL of the mid-point web page is stored within the parameter string, to which a finite-state-machine thread can append, or into which the finite state-machine can insert, the session ID obtained upon receiving the first, static web page from the source server. FIG. 10B shows the state-transition-based web-page navigation, in optimal fashion, to a mid-point page by two finite-state-machine threads within the client component of the intermediary session server, using the illustration conventions of FIGS. 8B and 9B, FIGS. 11A-B illustrate another type of mid-point page. So far, mid-point pages resulting from the association of session IDs to web pages by source servers have been described. However, there are additional types of mid-point pages. For example, as shown in FIG. 11A, a user may request a form-type web page 1102 through a static URL 1104, fill or partially fill out the form by inputting user input, including numerical, text, mouse-click, or combined numerical and text entries, into input windows, such as input window 1106, and then invoke the web browser to request from a source server a subsequent page that depends on input to the first form-type page. The user's web browser employs a URL embedded in the first web page, along with the information input by the user to the form, in order to obtain the subsequent web page. In one commonly used form-request method, the information input by the user into input windows is packaged within the message body, rather than the message header, of an HTML document request in the HTTP protocol. By including the input information in the message body, different web pages may be returned by the source server in response to identical form-request headers, or URLs. For example, as shown in FIG. 11A, depending on how a user fills out the first form-type web page 1102, different subsequent web pages 1108 and 1110 may be returned in response to identical URL-based requests 1112 and 1114. Depending on which web page is returned, different eventual result pages 1116 and 1118 may be subsequently obtained by the user from the two different mid-point web pages 1108 and 1110, both specified by the same URL 112 and 114. In this case, there may be no session ID associated with the web pages. Nonetheless, the web pages are associated with state, the state comprising user input to a previous web page. FIGS. 12A-C show the entities illustrated in FIGS. 11A-B in greater detail, for the convenience of the reader.

As an example of the above-described alternative type of mid-point web page, a user may wish to repeatedly access the source server for flight information for flights between Seattle and San Francisco at different points in time. It would be convenient for the user to be able to bookmark and directly access mid-point web pages 1108 and 1110, rather than needing to navigate to the mid-point web pages by inputting information into the initial web page 1102. Moreover, it would be beneficial to Internet users for search engines to be able to return URLs to such mid-point web pages. The intermediary session server discussed above with reference to FIGS. 6-10 can be used to properly return mid-point pages of the type discussed with reference to FIG. 11A by the same technique used to return mid-point pages associated with session IDs. FIG. 11B shows the input-entry portions of the web pages shown in FIG. 11A at larger scale. The intermediary session server may actually be incorporated within the search engine so that the search engine can directly display partially filled-out form-type web pages, or portions of partially filled-out form-type web pages.

FIG. 7 illustrates a general case for finite-state-machine operation. However, a finite state machine may undertake alternative types of operation, depending on the nature of the mid-point page. As discussed above, there are a number of different types of mid-point pages: (1) session-ID-related mid-point pages, for which the finite-state-machine needs to acquire associated state by navigating a series of web pages; (2) optimized-session-ID-related mid-point pages, for which the finite-state-machine needs to acquire associated state from a web page early in a sequence of web pages, and then skip to the desire mid-point web page; (3) form mid-point web pages which the finite-state-machine needs to acquire and then partially or completely fill in requested information; and (4) other types of web pages associated with state. In most cases, the finite state machine begins with an initial URL and interacts with a server that serves a web page associated with the initial URL to obtain a desired, mid-point web page. The finite state machine's interaction with the server is specified by the contents of the parameter string provided to the finite state machine, although, in certain cases, a specialized finite state machine may be self contained, and not need a parameter string in order to carry out the needed state transitions corresponding to finite-state-machine/web-page-ever interactions. In the case of a finite state machine that obtains a session-ID-related mid-point page, the parameter string generally has the form “initial-URL/parsing-equation-1/parsing-equation-2/ . . . /parsing-equation-n,” with each parsing-equation substring specifying one of: (1) how the finite state machine can extract a subsequent URL or other web-page handle from a web page returned by the server in response to a previous request transmitted to the server by the finite state machine; (2) how the finite-state machine can extract a session ID from a currently received web page; and (3) how the finite state machine can associate the session ID with a mid-point web page, if necessary, when returning the mid-point web page to the server-side of the intermediary server. In many cases, only parsing equations of the first type are needed, because the session ID is embedded in a returned web page. In the case of a finite state machine that obtains an optimized-session-ID-related mid-point page, the parameter string generally has the same form, but parsing equations include at least one parsing equation that can effect a jump, or skip, of intermediate web pages in the pathway from the initial URL to the desired mid-point web page. In the case of a form web page, the parameter string generally has the form “initial-URL/parsing-equation-1/ . . . /parsing-equation-for-field-0_and_field-value-0/parsing-equation-for-field-1_and_field-value-1/ . . . /parsing-equation-for-field-n_and_field-value-n.” The initial URL and initial parsing equation string server to direct the finite state machine to navigate to the needed form, and the field parsing equations and field values direct the finite state machine to place the specified field values into each specified field of the form.

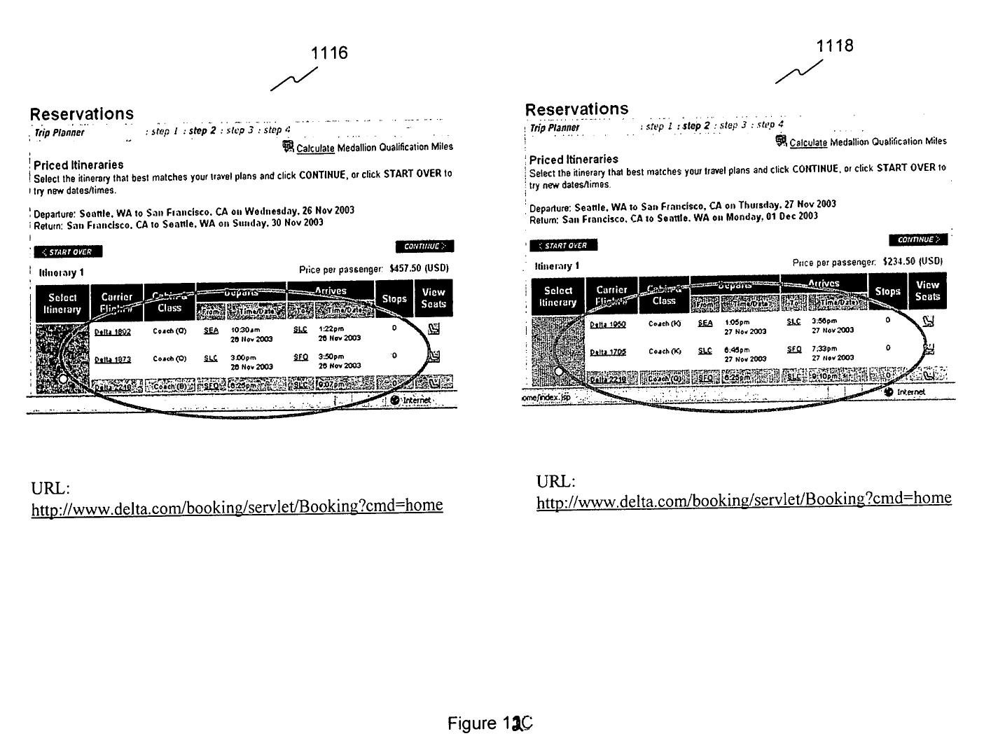

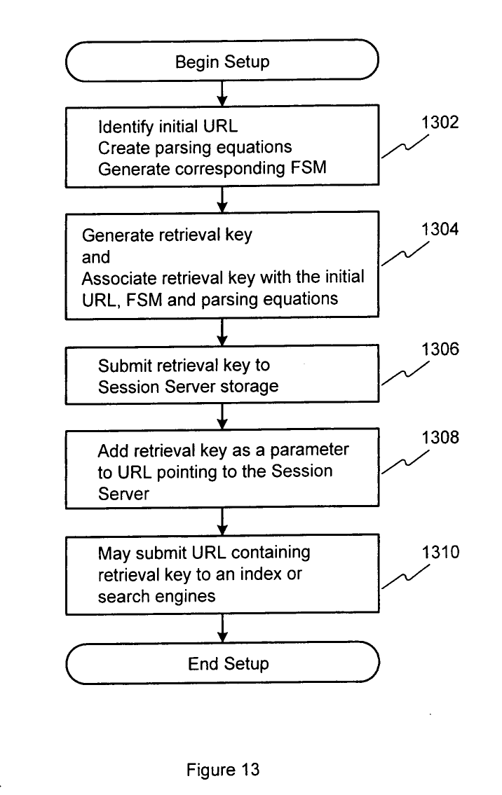

FIG. 13 is a control-flow diagram that shows an embodiment of the setup procedure for the intermediary session server. In step 1302, an initial URL for a mid-point web page to be accessed is identified, a parameter string for the mid-point web page is created, and the finite state machine needed to access the mid-point web page is generated. Next, in step 1304, a retrieval key is generated and associated with the initial-URL/FSM/parameter-string triple created in step 1302. In 1306, the initial-URL/FSM/parameter-string triple created in step 1302 is stored in a database for subsequent access using the retrieval key. The retrieval key is added, as a parameter, to the URL specifying access to the mid-point web page via the intermediary session server in step 1308, and, in step 1310, the URL is provided by the session server to one or more indexes, search engines, and/or client computers. Steps 1302-1310 may be incorporated within afor-loop in the case that a session server provides access to multiple mid-point web pages. Note also that an intermediary session server may provide access to initial web pages in addition to mid-point web pages.

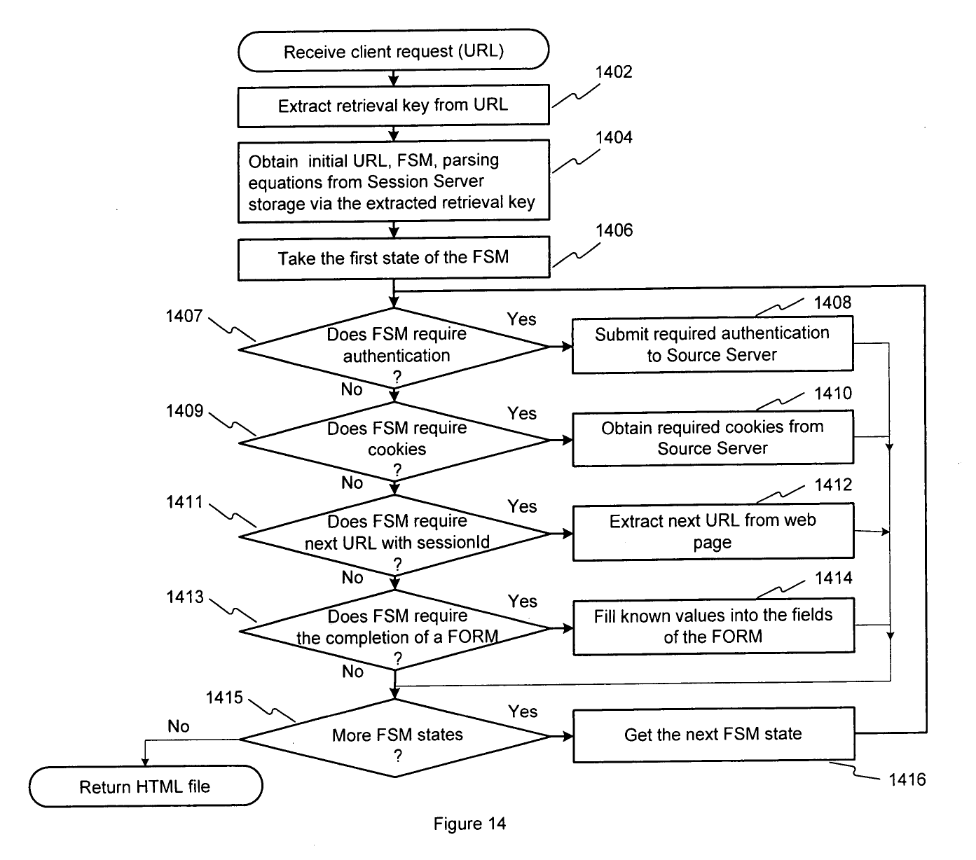

FIG. 14 is a control-flow diagram of one embodiment of the run-time operation of the session server. In one embodiment, the server is incorporated in the routine “Receive client request” shown in FIG. 14. This routine is executed by a thread within the session server for a URL request received from a client. In step 1402, the retrieval key is extracted from the URL. In step 1404, the routine obtains the initial-URL/FSM/parameter-string triple from a database that is associated with the extracted retrieval key. Then, in the for-loop comprising steps 1406-1416, the routine extracts each parameter substring from the parameter string of the initial-URL/FSM/parameter-string triple and carries out each transition specified by each parameter substring. In the conditional steps 1407, 1409, 1411, and 1413, the routine determines whether additional information needs to be supplied to the finite state machine in order to carry out the current transition, and, if so, obtains the needed information in steps 1408, 1410, 1412, and 1414. Needed information may include authentication information, such as a password, a cookie, a next URL extracted from a web page, and values for input fields within a web page previously obtained from a source server. If no more transitions are needed, as detected in conditional step 1415, the most recently obtained HTML document is returned to the requesting client computer. Otherwise, the next parameter substring is extracted from the parameter string, and the for-loop again iterates in order to carry out the transition specified by the extracted parameter substring.

Appendix A provides a Perl-like pseudocode implementation of the intermediary session server one time. Software developers ordinarily skilled in the art of server development will readily understand this pseudocode implementation, provided for further clarity and specificity as a supplement to the above, fully enabling description.

Although the present invention has been described in terms of a particular embodiment, it is not intended that the invention be limited to this embodiment. Modifications within the spirit of the invention will be apparent to those skilled in the art. For example, client-component finite state machines may be provided in an intermediary session server in order to personalize access to web-pages for each accessing user or client computer. An almost limitless number of different intermediary session server implementation can be created using different programming languages, control structures, modular organizations, data structures, and other such programming entities. Portions of, or a complete intermediary server may be implemented in hardware or firmware. The session-server database may be implemented using normal text and data files, a relational database management system, or other types of data storage facilities. Although two types of mid-point web pages are described above, an intermediary session server can provide direct access to a large number of different types of state-associated web pages. Although the disclosed embodiments provide mid-point web pages, mid-point, state-associated documents of any type, within any distributed document system, may be accessed and returned by alternative embodiments of the disclosed intermediary server, such as documents encoded in alternative markup languages or other document-specifying languages distributed through alternative communications systems amongst a number of processing entities, including computer systems. Although, in many applications, the intermediary server will be a separate processing entity from a client and a source server, the intermediary server functionality may be embedded, in alternative embodiments, within a client computer and/or within a source server.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. An intermediary server comprising:
a storage component that stores an association between a finite state machine and a document-location specifier;
a client component that executes a finite state machine corresponding to a mid-point document in order to obtain the mid-point document and a state associated with the mid-point document from a source server; and
a server component that
receives a document-location specifier specifying the mid-point document from a client computer,
retrieves the association between the finite state machine and the document-location specifier,
invokes the finite state machine to obtain the mid-point document and the state associated with the mid-point document from the source server, and
returns the mid-point document and state associated with the mid-point document to the client computer.

2. The intermediary server of claim 1 wherein stored associations further include a parameter string, and wherein the server component:
receives a document-location specifier specifying the mid-point document from a client computer,
retrieves the association between the finite state machine, a parameter string, and the document-location specifier,
invokes the finite state machine, passing to the finite state machine the parameter string, to obtain the mid-point document and the state associated with the mid-point document from the source server, and
returns the mid-point document and state associated with the mid-point document to the client computer.

3. The intermediary server of claim 2 wherein the storage component is one of:
a database management system;
a searchable list of finite-state-machine/parameter-string/document-location specifier associations stored in memory; and
a file-based storage component.

4. The intermediary server of claim 2 wherein document-location specifiers are URLs, a parameter string includes one or more parameter substrings, and each parameter substring specifying a step in a web-page navigation pathway.

5. The intermediary server of claim 4 wherein each parameter substring includes one of:
an indication of where to find a next URL; and
a next URL.

6. The intermediary server of claim 5 wherein the client component executes a finite state machine corresponding to a mid-point document by:
parsing the parameter string in order to extract each parameter substring in order; and
for each extracted parameter substring,
furnishing a URL specified in the extracted substring to the source server in order to obtain a document corresponding to the URL from the source server.

7. The intermediary server of claim 6 wherein execution of the finite state machine further includes obtaining additional information needed to be supplied along with a URL and supplying the additional information to the source server along with the URL specified in the extracted substring, additional information including one or more of:
an authentication;
a cookie;
input-field information.

8. The intermediary server of claim 2
wherein the intermediary server stores a plurality of associations between finite state machines and parameter strings; and
wherein the server component
receives URLs specifying mid-point documents from a plurality of client computers, and
for each received URL
extracts a retrieval key from the received URL;
retrieves an association between a finite-state-machine and a parameter-string corresponding to the received URL using the retrieval key,
invokes the finite state machine, furnishing the finite state machine with the parameter string, and
returns a mid-point document and state returned by the finite state machine to the client computer.

9. A method for returning to a requesting client computer a mid-point document, the method comprising:
receiving a document-location specifier from the client computer specifying the mid-point document;
finding a stored association between a finite state machine corresponding to the received document-location specifier;
invoking the finite state machine to receive the mid-point document and state associated with the mid-point document from a source server; and
returning the mid-point document and state associated with the mid-point document to the client computer.

10. The method of claim 9 wherein the stored association further includes a parameter string, and wherein the parameter string is passed to the finite state machine upon invoking the finite state machine.

11. The method of claim 9 wherein the document-location specifier received from the client computer includes a retrieval key, and finding a stored association between a finite state machine and a parameter string corresponding to the received document-location specifier further includes extracting the retrieval key from the received document-location specifier and using the extracted retrieval key to find the stored association between a finite state machine and a parameter string corresponding to the received document-location specifier.

12. The method of claim 11 wherein the parameter string includes a number of parameter substrings and wherein invoking the finite state machine with the parameter string to receive the mid-point document and state associated with the mid-point document from a source server further includes:
parsing the parameter string in order to extract each parameter substring in order; and
for each extracted parameter substring,
furnishing a document-location specifier specified in the extracted substring to the source server in order to obtain a document corresponding to the document-location specifier from the source server.

13. The method of claim 11 wherein furnishing a document-location specifier specified in the extracted substring to the source server in order to obtain a document corresponding to the document-location specifier from the source server further includes obtaining additional information needed to be supplied along with a document-location specifier and supplying the additional information to the source server along with the document-location specifier specified in the extracted substring, additional information including one or more of:
an authentication;
a cookie;
input-field information.

14. The method of claim 9 encoded in computer instructions stored in a computer readable medium.
